(19) United States
(12) Patent Application Publication
(10) Pub. No.: US 2005/0271574 A1
(43) Pub. Date: Dec. 8, 2005

(54) Process for producing nano-scaled graphene plates

(76) Inventors: Bor Z. Jang, Fargo, ND (US); Laixia Yang, Fargo, ND (US); Shing-Chung Wong, West Fargo, ND (US); Yanjun Bai, Fargo, ND (US)

Correspondence Address: Bor Z. Jang, 2902, 28 AVE, S.W., FARGO, ND, 58103, US

(21) Appl. No.: 10/858,814

(22) Filed: Jun. 3, 2004

(51) Int. Cl. C01B 31/04

(52) U.S. Cl. 423/448

(57) ABSTRACT

A process for producing nano-scaled graphene plates with each plate comprising a sheet of graphite plane or multiple sheets of graphite plane with the graphite plane comprising a two-dimensional hexagonal structure of carbon atoms. The process includes the primary steps of: (a) providing a powder of fine graphite particles comprising graphite crystallites with each crystallite comprising one sheet or normally a multiplicity of sheets of graphite plane bonded together; (b) exfoliating the graphite crystallites to form exfoliated graphite particles, which are characterized by having at least two graphite planes being either partially or fully separated from each other; and (c) subjecting the exfoliated graphite particles to a mechanical attrition treatment to further reduce at least one dimension of the particles to a nanometer scale, <100 nm, for producing the nano-scaled graphene plates.

### FIELD OF THE INVENTION

The present invention relates generally to a process for producing nano-scaled carbon materials and, particularly, to nano-scaled thin-plate carbon materials, hereinafter referred to as nano-scaled graphene plates (NGPs).

### BACKGROUND

Carbon is known to have four unique crystalline structures, including diamond, graphite, fullerene and carbon nano-tubes. The carbon nano-tube (CNT) refers to a tubular structure grown with a single wall or multi-wall, which can be conceptually obtained by rolling up a graphene sheet (or graphene plane) or several graphite sheets to form a concentric hollow structure. A graphene plane is composed of carbon atoms occupying a two-dimensional hexagonal lattice. Carbon nano-tubes have diameters on the order of a few nanometers to a few hundred nanometers. Carbon nano-tubes can function as either a conductor or a semiconductor, depending on the rolled shape and the diameter of the tubes. Its longitudinal, hollow structure imparts unique mechanical, electrical and chemical properties to the material. Carbon nano-tubes are believed to have great potential for use in field emission devices, hydrogen fuel storage, rechargeable battery electrodes, and composite reinforcements.

The processes for producing CNTs are now well-known. Originally, S. Iijima produced CNTs by an arc discharge between two graphite rods. However, yield of pure CNTs with respect to the end product is only about 15%. Thus, a complicated purification process must be carried out for particular device applications.

Another approach to the preparation of CNTs at high temperature is by irradiating a laser onto graphite or silicon carbide. In this approach, the carbon nanotubes are produced from graphite at about 1,200° C. or higher and from silicon carbide at about 1,600 to 1,700° C. This approach also requires multiple stages of purification, which increases the cost. In addition, this approach has difficulties in large-device applications.

CNTs may be produced through a thermal decomposition of hydrocarbon gases by chemical vapor deposition (CVD). This technique is applicable only with a gas that is unstable, such as acetylene or benzene. For example, a methane (CH₄) gas cannot be used to produce carbon nanotubes by this technique. A CNT layer may be grown on a substrate using a plasma chemical vapor deposition method at a high density of 10¹¹ cm⁻³ or more. The substrate may be an amorphous silicon or polysilicon substrate on which a catalytic metal layer is formed. In the growth of the CNT layer, a hydrocarbon series gas may be used as a plasma source gas, the temperature of the substrate may be in the range of 600 to 900° C., and the pressure may be in the range of 10 to 1000 mTorr.

In summary, CNTs are extremely expensive due to the low yield and low production and purification rates commonly associated with all of the current CNT preparation processes. The high material costs have significantly hindered the widespread application of nano-tubes. Rather than trying to discover much lower-cost processes for nano-tubes, we have worked diligently to develop alternative nano-scaled carbon materials that exhibit comparable properties, but are more readily available and at much lower costs.

This development work has led to the discovery of a process for producing individual nano-scaled graphite planes (individual graphene sheets) and stacks of multiple nano-scaled graphene sheets, which are collectively called “nano-sized graphene plates (NGPs).” NGPs could provide unique opportunities for solid state scientists to study the structures and properties of nano carbon materials. The structures of these materials may be best visualized by making a longitudinal scission on the single-wall or multi-wall of a nano-tube along its tube axis direction and then flattening up the resulting sheet or plate (FIG. 1). Studies on the structure-property relationship in isolated NGPs could provide insight into the properties of a fullerene structure or nano-tube. Furthermore, these nano materials could potentially become cost-effective substitutes for carbon nano-tubes or other types of nano-rods for various scientific and engineering applications.

Direct synthesis of the NGP material had not been possible, although the material had been conceptually conceived and theoretically predicted to be capable of exhibiting many novel and useful properties. Jang and Huang have provided an indirect synthesis approach for preparing NGPs and related materials [B. Z. Jang and W. C. Huang, “Nano-scaled Graphene Plates and Process for Production,” U.S. Pat. Pending, (Ser. No. 10/274,473) Oct. 21, 2002]. This earlier process entailed the following procedures: (1) partially or fully carbonizing a variety of precursor polymers, such as polyacrylonitrile (PAN) fibers and phenol-formaldehyde resin, or heat-treating petroleum or coal tar pitch, (2) exfoliating the resulting carbon- or graphite-like structure, and (3) mechanical attrition (e.g., ball milling) of the exfoliated structure to become nano-scaled. The carbonization procedures could be tedious and the resulting carbon- or graphite-like structure tends to contain a significant portion of amorphous carbon structure and, hence, a lower-than-desired yield. The present invention provides a faster and more cost-effective process for producing large quantities of NGPs. The process is estimated to be highly cost-effective.

### SUMMARY OF THE INVENTION

As a preferred embodiment of the presently invented process, NGPs can be readily produced by the following procedures: (1) providing a graphite powder containing fine graphite particles (particulates, short fiber segments, carbon whisker, graphitic nano-fibers, or combinations thereof) preferably with at least one dimension smaller than 200 μm (most preferably smaller than 1 μm); (2) exfoliating the graphite crystallites in these particles in such a manner that at least two graphene planes are either partially or fully separated from each other, and (3) mechanical attrition (e.g., ball milling) of the exfoliated particles to become nano-scaled to obtain the resulting NGPs. The starting powder type and size, exfoliation conditions (e.g., intercalation chemical type and concentration, temperature cycles, and the mechanical attrition conditions (e.g., ball milling time and intensity) can be varied to generate, by design, various NGP materials with a wide range of graphene plate thickness, width and length values. Ball milling is known to be an effective process for mass-producing ultra-fine powder particles. The processing ease and the wide property ranges that can be achieved with NGP materials make them promising candidates for many important engineering applications. The electronic, thermal and mechanical properties of NGP materials are expected to be comparable to those of carbon nano-tubes; but NGP will be available at much lower costs and in larger quantities.

### BRIEF DESCRIPTION OF THE DRAWINGS

FIG. 1 conceptually illustrates the configuration difference between a carbon nano-tube (CNT) and a nano-scaled graphene plate (NGP); (A) single-walled CNT, (B) single-layer NGP, (C) multi-walled CNT, and (D) multi-layer NGP.

FIG. 2 Micrograph showing (A) un-exfoliated graphite, (B) separate graphene planes of an exfoliated graphite, and (C) an isolated NGP.

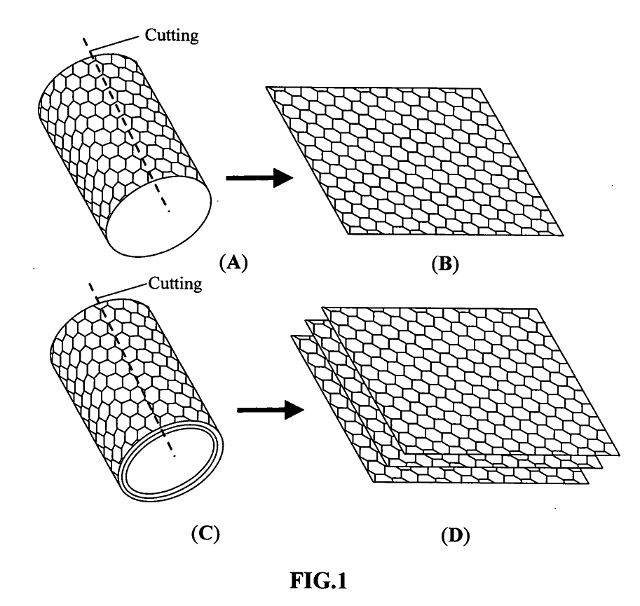

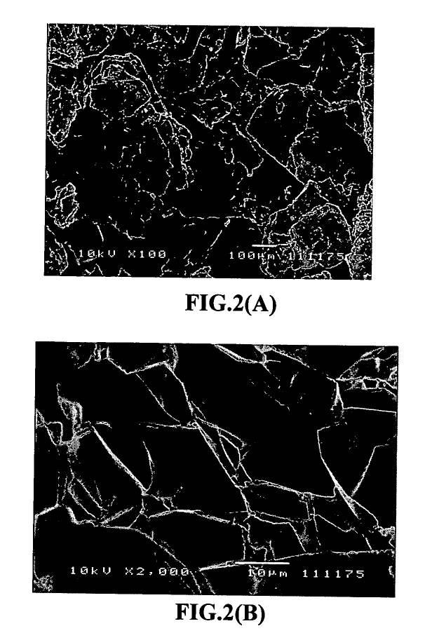

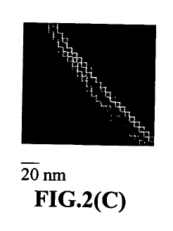

### DETAILED DESCRIPTION OF PREFERRED EMBODIMENTS

One preferred embodiment of the present invention is a process for producing a nano-scaled graphene plate (NGP) material that is essentially composed of a sheet of graphite plane or multiple sheets of graphite plane stacked and bonded together. Each graphite plane, also referred to as a graphene plane or basal plane, comprises a two-dimensional hexagonal structure of carbon atoms. Each plate has a length and a width parallel to the graphite plane and a thickness orthogonal to the graphite plane. At least one of the values of length, width, and thickness is 100 nanometers (nm) or smaller. The length and width of a GNP could exceed 1 μm. Preferably, however, all of the dimensions are smaller than 100 nm.

The NGP material can be produced by a process comprising the following steps (a) providing a powder of fine graphite particles, which are graphite particulates (or flakes), carbon fiber segments, carbon whisker, graphitic nano-fibers, or combinations thereof and which contain graphite crystallites (typically micrometer- or nanometer-sized), (b) exfoliation or expansion of the graphite crystallites in the graphite particles to delaminate or separate graphene planes, and (c) mechanical attrition of the exfoliated particles to nanometer-scale to obtain the NGPs.

The first step involves preparing a graphite powder containing fine graphite particulates (granules) or flakes, short segments of carbon fiber (including graphite fiber), carbon or graphite whiskers or nano-fibers, or their mixtures. The length and/or diameter of these graphite particles are preferably less than 0.2 mm (200 μm), further preferably less than 0.01 mm (10 μm), and most preferably smaller than 1 μm. The graphite particles are known to typically contain micron- and/or nanometer-scaled graphite crystallites with each crystallite being composed of one sheet or several sheets of graphite plane. Preferably, the graphite particles, if being of larger dimensions when supplied, are pulverized, chopped, or milled to become small particles or short fiber segments, with a dimension preferably smaller than 0.2 mm, further preferably smaller than 0.01 mm and most preferably smaller than 1 μm before the second step of exfoliation is carried out. The reduced particle sizes facilitate fast diffusion or migration of an exfoliating or intercalating agent into the interstices between graphite planes in graphite crystallites.

The second step involves exfoliating the graphite crystallites in the graphite particles. Exfoliation typically involves a chemical treatment, intercalation, foaming, microwaving and/or heating steps. The purpose of the exfoliation treatment is to delaminate (at least crack open) the graphene planes or to partially or fully separate graphene planes in a graphite crystallite.

The third step includes subjecting the particles containing exfoliated graphite crystallites to a mechanical attrition treatment to further reduce the particles to a nanometer scale for producing the desired nano-scaled graphene plates. With this treatment, either the individual graphene planes (one-layer NGPs) or stacks of graphene planes bonded together (multi-layer NGPs) are reduced to become nanometer-sized. In addition to the thickness dimension being nano-scaled, both the length and width of these NGPs could be reduced to be smaller than 100 nm in size. In the thickness direction (or c-axis direction normal to the graphene plane), there may be a small number of graphene planes that are still bonded together through the van der Waal's forces that commonly hold the basal planes together in a natural graphite. Preferably, there are less than 20 layers (further preferably less than 5 layers) of graphene planes, each with length and width smaller than 100 nm, that constitute a multi-layer NGP material produced after mechanical attrition. Preferred embodiments of the present invention are further described as follows:

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene plates (sheets of graphene planes or basal planes) that are bonded together through van der Waals forces in the c-direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, or carbon/graphite whisker or nano-fiber. In the case of a carbon or graphite fiber segment, the graphene plates may be a part of a characteristic “turbostratic structure.”

Exfoliation Treatment: In general, for the purpose of exfoliating graphene plane layers, the chemical treatment of the graphite powder involves subjecting particles of a wide range of sizes to a chemical solution for periods of time ranging from about one minute to about 48 hours. The chemical solution was selected from a variety of oxidizing or intercalating solutions maintained at temperatures ranging from about room temperature to about 125° C. The graphite particles utilized can range in size from a fine powder small enough to pass through a 325 mesh screen to a size such that no dimension is greater than about one inch or 25.4 mm. Larger-sized particles may be reduced to a size smaller than 0.2 mm or, preferably, smaller than 0.01 mm to achieve reduced chemical treatment times. The concentrations of the various compounds or materials employed, e.g. H₂SO₄, HNO₃, KMₙO₄, and FₑCl₃, ranged from about 0.1 normal to concentrated strengths. Ratios of H₂SO₄ to HNO₃ were also varied from about 9:1 to about 1:1 to prepare a range of acid mixtures. The chemical treatment may include interlayer chemical attack and/or intercalation, followed by a heating cycle. Exfoliation may also be achieved by using a foaming or blowing agent, which by itself is a well-known art.

Interlayer chemical attack of graphite particles is preferably achieved by subjecting the particles to oxidizing conditions. Various oxidizing agents and oxidizing mixtures may be employed to achieve a controlled interlayer chemical attack. For example, there may be utilized nitric acid, potassium chlorate, chromic acid, potassium permanganate, potassium chromate, potassium dichromate, perchloric acid and the like, or mixtures such as, for instance, concentrated nitric acid and potassium chlorate, chromic acid and phosphoric acid, sulfuric acid and nitric acid, etc, or mixtures of a strong organic acid, e.g. trifluoroacetic acid and a strong oxidizing agent soluble in the organic acid used. A wide range of oxidizing agent concentrations can be utilized. Oxidizing agent solutions having concentrations ranging from 0.1 normal to concentrated strengths may be effectively employed to bring about interlayer attack. The acids or the like utilized with the oxidizing agents to form suitable oxidizing media or mixtures can also be employed in concentrations ranging from about 0.1 normal to concentrated strengths.

In one embodiment, the oxidizing medium comprises sulfuric acid and an oxidizing agent such as nitric acid, perchloric acid, chromic acid, potassium permanganate, iodic or periodic acids or the like. One preferred oxidizing medium comprises sulfuric and nitric acids. The ratio of sulfuric acid to oxidizing agent, and more particularly, nitric acid can range from about 9:1 or higher to about 1:1. Likewise, various sulfuric and nitric acid concentrations can be employed, e.g. 0.1 N, 1.0 N, 10 N and the like. Generally, the concentrations of the sulfuric acid and nitric acid, which can be effectively utilized, range from about 0.1 normal to concentrated strengths.

The treatment of graphite particles with oxidizing agents or oxidizing mixtures such as mentioned above is preferably carried out at a temperature between room temperature and about 125° C. and for duration of time sufficient to produce a high degree of interlayer attack. The treatment time will depend upon such factors as the temperature of the oxidizing medium, grade or type of graphite particles treated, particle sizes, amount of expansion desired and strength of the oxidizing medium.

The opening up or splitting apart of graphene layers can also be achieved by chemically treating graphite particles with an intercalating solution or medium, hereafter referred to as intercalant, so as to insert or intercalate a suitable additive between the carbon hexagon networks (i.e., between graphene planes) and thus form an addition or intercalation compound of carbon. For example, the additive can be a halogen such as bromine or a metal halide such as ferric chloride, aluminum chloride, or the like. A halogen, particularly bromine, may be intercalated by contacting the graphite particles with bromine vapors or with a solution of bromine in sulfuric acid or with bromine dissolved in a suitable organic solvent. Metal halides can be intercalated by contacting the graphite particles with a suitable metal halide solution. For example, ferric chloride can be intercalated by contacting graphite particles with a suitable aqueous solution of ferric chloride or with a mixture comprising ferric chloride and sulfuric acid. Temperature, times, and concentrations of reactants similar to those mentioned earlier for oxidation treatments can also be employed for the above intercalation processes.

It may be noted that smaller graphite particles are preferred due to the observation that smaller dimensions allow for not only faster diffusion but also more uniform dispersion of the chemical treatment or intercalation agents in the interstices between graphene layers. This tends to result in the production of NGPs of more uniform thicknesses. This is why the presently invented process preferably begins with the preparation of fine graphite or carbon particles.

Upon completion of the treatment directed to promoting interlayer attack, the thoroughly wetted or soggy graphite particles can be subjected to conditions for bringing about the expansion thereof. Preferably, however, the treated graphite particles are rinsed with an aqueous solution. The rinsing or washing of the treated particles/fibers with aqueous solution may serve several purposes. For instance, the rinsing or leaching removes harmful materials, e.g. acid, from the particles so that it can be safely handled. Acid could otherwise decompose the intercalated material. Furthermore, it can also serve as the source of the blowing or expanding agent, which is to be incorporated between layers. Specifically, it can serve as the source of water if water is to be utilized as the foaming, blowing or expanding agent.

The c-direction expansion is brought about by activating a material such as a suitable foaming or blowing agent which has been incorporated between layers of parallel carbon networks, the incorporation taking place either during the interlayer attack treatment or thereafter. The incorporated foaming or blowing agent upon activation such as by chemical interaction or by heat generates a fluid pressure, which is effective to cause c-direction expansion of the graphite particles. Preferably, a foaming or blowing agent is utilized which when activated forms an expanding gas or vapor which exerts sufficient pressure to cause expansion.

A wide variety of well-known foaming and blowing agents can be employed. For example, expanding agents such as water, volatile liquids, liquid nitrogen and the like, which change their physical state during the expansion operation, can be used. When an expanding agent of the above type is employed, the expansion of the treated graphite particles is preferably achieved by subjecting the treated particles to a temperature sufficient to produce a gas pressure which is effective to bring about an almost instantaneous and maximum expansion of the particles. For instance, when the expanding agent is water, the particles having water incorporated in the structure are preferably rapidly heated or subjected to a temperature above 100° C. so as to induce a substantially instantaneous and full expansion of the particles. If such particles to be expanded are slowly heated to a temperature above 100° C., substantial water will be lost by vaporization from the structure resulting in drying of the structure so that much lesser degree of expansion will be achieved. Preferably, the substantially complete and full expansion of the particles is accomplished within a time of from about a fraction of a second to about 2 minutes, more typically from 1 second to 20 seconds. This can be conducted by pre-heating a furnace to a temperature in the range of 200°-2,500° C., but most preferably in the range of 500° C.-1,500° C. The chemically treated or intercalated sample is then quickly placed in the heated zone for a duration of time sufficient to cause expansion.

Microwave heating was found to be particularly effective and energy-efficient in heating to exfoliate fine graphite particles. Although the presence of some moisture appears to promote exfoliation of minute graphite particles, it is not a necessary requirement when the chemically treated sample is microwave-heated. It may take minutes for a microwave oven to heat and exfoliate a treated graphite sample, as opposed to seconds for the cases of pre-heating a furnace of an ultra-high temperature (e.g., 1,500° C.). However, the amount of energy required is much smaller for microwave heating.

In addition to physical expanding methods described above, the expanding gas can be generated in situ, that is, between layers of carbon networks by the interaction of suitable chemical compounds or by the use of a suitable heat sensitive additive or chemical blowing agent.

As indicated previously, the graphite particles are so treated with a suitable oxidizing medium and unrestrictedly expanded that there is preferably produced expanded carbon or graphite masses having expansion ratios of at least 20 to 1 (further preferably higher than 50 to 1). In other words, the expanded graphite particles have a thickness or c-direction dimension in the graphite crystallite at least 50 times of that of the un-expanded crystallite. The expanded carbon particles are unitary, laminar structure having a vermiform appearance. The vermiform masses are lightweight, anisotropic graphite-based materials.

The intercalation treatment is further described in what follows: Graphite is a crystalline form of carbon comprising hexagonally arranged atoms bonded in flat layered planes, commonly referred to as basal planes or graphene planes, with van der Waal's bonds between the planes. By treating particles of graphite, such as natural graphite flake, with an intercalant of, e.g., a solution of sulfuric and nitric acid, the crystal structure of the graphite reacts to form a compound of graphite and the intercalant. The treated particles of graphite are hereafter referred to as intercalated graphite flake. Upon exposure to elevated temperatures the particles of intercalated graphite expand in dimension in an accordion-like fashion in the c-direction, i.e. in the direction perpendicular to the basal planes of the graphite. In a similar fashion, the presently prepared graphite particles can be subjected to intercalation and high-temperature expansion treatment to obtain a graphite powder containing expanded graphene planes. The graphite powder is typically intercalated by dispersing the graphite particles in a solution containing an oxidizing agent, such as a mixture of nitric and sulfuric acid. After the particles are intercalated excess solution is drained from the particles. The quantity of intercalation solution retained on the particles or fibers after draining is typically greater than 50 parts of solution by weight per 100 parts by weight of carbon (pph) and more typically about 50 to 100 pph.

The intercalant of the present invention contains oxidizing intercalating agents known in the art of Graphite Intercalation Compound (GIC). As mentioned earlier, examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid.

In a preferred embodiment of the invention, the intercalant is a solution of sulfuric acid, or sulfuric acid and phosphoric acid, and an oxidizing agent, i.e. nitric acid, perchloric acid, chromic acid, potassium permanganate, iodic or periodic acids, or the like, and preferably also includes an expansion aid as described below. The intercalant may contain metal halides such as ferric chloride, and ferric chloride mixed with sulfuric acid, or a halogen, such as bromine as a solution of bromine and sulfuric acid or bromine in an organic solvent.

The graphite particles treated with intercalant are contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include the following: hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, propylene glycol monooleate, glycerol monostearate, glycerol monooleate, dimethyl oxylate, diethyl oxylate, methyl formate, ethyl formate and ascorbic acid. Depending upon the treatment chemicals used, the edges could have different functional groups or elements attached thereto.

Mechanical Attrition: The exfoliated particles were then submitted to a mechanical attrition treatment to further separate graphene planes and reduce the sizes of particles to be nanometer-scaled. Attrition can be achieved by pulverization, grinding, milling, etc., but the most effective method of attrition is ball-milling. High-energy planetary ball mills were found to be particularly effective in producing nano-scaled graphene plates. Since ball milling is considered to be a mass production process, the presently invented process is capable of producing large quantities of NGP materials cost-effectively. This is in sharp contrast to the production and purification processes of carbon nano-tubes, which are slow and expensive.

The ball milling procedure, when down-sizing the particles, tend to produce free radicals at peripheral edges of graphene planes. These free radicals are inclined to rapidly react with non-carbon elements in the environment. These non-carbon atoms may be selected to produce desirable chemical and electronic properties. Non-carbon atoms typically include hydrogen, oxygen, nitrogen, sulphur, and combinations thereof.

### EXAMPLE 1

One hundred grams of natural graphite flakes ground to approximately 0.2 mm or less in sizes, were treated in a mixture of sulfuric and nitric acids at concentrations to yield the desired intercalation compound. The product was water washed and dried to approximately 1% by weight water. The dried particles were introduced into a furnace at 1,250° C. to effect extremely rapid and high expansions of graphite crystallites. The exfoliated graphite particles were then ball-milled in a high-energy plenary ball mill machine for 24 hours to produce nano-scaled particles.

### EXAMPLE 2

Same as in Example 1, but the starting material was a carbon fiber chopped into segments with 0.2 mm or smaller in length prior to the acid solution treatment.

### EXAMPLE 3

A powder sample of carbon whiskers or graphitic nano-fibers was prepared by introducing an ethylene gas through a quartz tube pre-set at a temperature of approximately 800° C. A small amount of Cu—Ni powder was positioned on a crucible to serve as a catalyst, which promote the decomposition of the hydrocarbon gas and growth of carbon whiskers. Approximately 2.5 grams of the carbon whiskers were intercalated with 2.5 grams of intercalant consisting of 86 parts by weight of 93% sulfuric acid and 14 parts by weight of 67% nitric acid. The particles were then placed in a 90° C. oven for 20 minutes. The intercalated particles were then washed with water. After each washing the particles were filtered by vacuum through a Teflon screen. After the final wash the particles were dried for 1 hour in a 115° C. oven. The dried particles were then rapidly heated to approximately 1,000° C. to further promote expansion. Samples containing exfoliated graphite crystallites were then ball-milled to become nanometer-sized powder.

### EXAMPLE 4

Same as in Example 3, but heating was accomplished by placing the intercalated sample in a microwave oven using a high-power mode for 3-10 minutes. Very uniform exfoliation was obtained.

1. A process for producing nano-scaled graphene plates with each plate comprising a sheet of graphite plane or multiple sheets of graphite plane with said graphite plane comprising a two-dimensional hexagonal structure of carbon atoms, said process comprising the steps of:
a). providing a fine powder of graphite particles substantially smaller than 200 μm; said particles comprising graphite crystallites each comprising multiple sheets of graphite plane bonded together;
b). exfoliating said graphite crystallites to form exfoliated graphite particles, which are characterized by having at least two graphite planes being either partially or fully separated from each other; and
c). subjecting said exfoliated graphite particles to a mechanical attrition treatment to reduce at least one dimension of said particles to a nanometer scale, <100 nm, for producing said nano-scaled graphene plates.

2. The process for producing nano-scaled graphene plates as defined in claim 1, wherein said step of exfoliating comprises subjecting said graphite particles to a treatment selected from the group consisting of an interlayer chemical attack, intercalation, foaming, heating, and combinations thereof.

3. The process for producing nano-scaled graphene plates as defined in claim 2, wherein said step of exfoliating comprises an interlayer chemical attack or intercalation treatment, followed by heating.

4. The process for producing nano-scaled graphene plates as defined in claim 3, wherein said heating step comprises pre-heating a furnace to a desired temperature and then rapidly placing said graphite particles, after said interlayer chemical attack or intercalation treatment, in said furnace for a duration of time sufficient to cause exfoliation.

5. The process for producing nano-scaled graphene plates as defined in claim 1, wherein said sub-step of heating comprises microwave heating.

6. The process for producing nano-scaled graphene plates as defined in claim 1, wherein said step of exfoliating comprises contacting said graphite particles with an oxidizing agent selected from the group consisting of nitric acid, potassium chlorate, chromic acid, potassium permanganate, potassium chromate, potassium dichromate, perchloric acid, phosphoric acid, sulfuric acid, trifluoroacetic acid, organic acid, and mixtures thereof.

7. The process for producing nano-scaled graphene plates as defined in claim 1, wherein said mechanical attrition treatment comprises a ball milling treatment of said exfoliated graphite particles.

8. The process for producing nano-scaled graphene plates as defined in claim 1, wherein said mechanical attrition treatment comprises operating a high-energy planetary ball mill.

9. The process for producing nano-scaled graphene plates as defined in claim 1, wherein said graphite particles in step (a) have a dimension smaller than 1 μm.

10. The process for producing nano-scaled graphene plates as defined in claim 1, wherein said graphite particles comprise segments of a carbon fiber, whisker or graphitic nano-fiber.

11. The process for producing nano-scaled graphene plates as defined in claim 1, wherein said plates each has a length and a width parallel to said graphite plane and a thickness orthogonal to said graphite plane with the values of length, width, and thickness being all 100 nanometers or smaller.

12. The process for producing nano-scaled graphene plates as defined in claim 1, wherein at least one of said plates is composed of one to five sheets of graphite plane.

13. The process for producing nano-scaled graphene plates as defined in claim 1, wherein at least one sheet of graphite plane is bounded by a peripheral edge containing non-carbon atoms.

14. The process for producing nano-scaled graphene plates as defined in claim 10, wherein said non-carbon atoms are selected from the group consisting of hydrogen, oxygen, nitrogen, sulphur, and combinations thereof.
